(19) United States
(12) Patent Application Publication
(10) Pub. No.: US 2004/0125128 A1
(43) Pub. Date: Jul. 1, 2004

(54) Graphical user interface for a slideshow presentation

(76) Inventors: Cheng-Chia Chang, Tainan (TW); Kuang-Rong Lu, Taipei (TW); Shih-Chang Han, Taipei (TW)

Correspondence Address: BIRCH STEWART KOLASCH & BIRCH, PO BOX 747, FALLS CHURCH, VA, 22040-0747, US

(21) Appl. No.: 10/327,874

(22) Filed: Dec. 26, 2002

(51) Int. Cl. G09G 5/00

(52) U.S. Cl. 345/730

(57) ABSTRACT

A graphical user interface for a slideshow presentation. The graphical user interface comprises: a selection controller by which slides in the slideshow are previewed in sequence when a first event occurs and one of the previewed slides is selected when a second event occurs; a preview window displaying a thumbnail for each of the slides currently previewed by the selection controller; and a main window displaying the slide selected by the selection controller.

### BACKGROUND OF THE INVENTION

1. Field of the Invention

The present invention relates to a graphical user interface and particularly to a graphical user interface and method for a slideshow presentation.

2. Description of the Related Art

Generally, software applications for a slideshow presentation sequentially index the slides in the slideshow and display the slides in the order of their indices by default. The slides may be sequentially switched in predetermined time intervals or by a user-triggered event such as a mouse click. Occasionally, the user may want the slides to be displayed non-sequentially, that is to say, the slides are switched in an arbitrary order as the user wishes. Accordingly, the software applications also generally provide a graphical user interface for a presentation of the slideshow in this way.

FIG. 1 is a diagram showing a conventional graphical user interface for a non-sequential slideshow presentation. When the user right-clicks the currently displayed slide, a menu 11 appears, with items from which the user can select a slide or action. If the user selects the item “Next” or “Previous”, the slide with an index next or previous to that currently displayed will be switched to. If the user wants to have a slide far from that currently displayed, the item “Go” is selected, and a sub-menu 12 appears from which the user can select a means by which the target slide can be located. It is noted that the sub-menu 12 has items “By Title” and “Previously Viewed”. If the user selects the item “Previously Viewed”, the slide displayed previously to the current one displays. If the item “By Title” is selected, another sub-menu 13 appears listing indices and titles for the user's selection. Thus, the slides are displayed in an order of their sequential indices by default until the user right-clicks the currently displayed slide to activate the menus for a non-sequential presentation.

However, it is not convenient for the user to execute a non-sequential presentation using the previously described graphical user interface, especially when the desired slide is far from that currently displayed. The user needs to identify the target slide from among a large number of indices and titles listed in the sub-menu 13. Even worse, the user usually has the content of the target slide in mind but may forget its index or title. In such a situation, the user needs to identify the target slide by trial and error, which makes the presentation troublesome.

### SUMMARY OF THE INVENTION

The object of the present invention is to provide a smarter graphical user interface for a non-sequential slideshow presentation.

The present invention provides a graphical user interface for a slideshow presentation, comprising a selection controller by which slides in the slideshow are first previewed in sequence when a first event occurs and one of the previewed slides is selected when a second event occurs, a preview window displaying a thumbnail for each of the slides currently previewed by the selection controller, and a main window displaying the slide selected by the selection controller.

The present invention further provides a method for a slideshow presentation comprising the step of previewing in sequence slides in the slide show when a first event occurs and selecting one of the previewed slides when a second event occurs, displaying a thumbnail for each of the slides currently previewed in a preview window, and displaying the selected slide in a main window.

Thus, in the present invention, the user can sequentially preview and preview the content of the slides by simply dragging or rotating the selection controller, with no need for troublesome menu manipulation.

### BRIEF DESCRIPTION OF THE DRAWINGS

The preferred embodiment of the invention is hereinafter described with reference to the accompanying drawings in which:

FIG. 1 is a diagram showing a conventional graphical user interface for a non-sequential slideshow presentation.

FIG. 2 is a diagram showing a method for a non-sequential slideshow presentation according to one embodiment of the invention.

FIGS. 3A and 3B are diagrams showing graphical user interfaces for a non-sequential slideshow presentation according to embodiments of the invention.

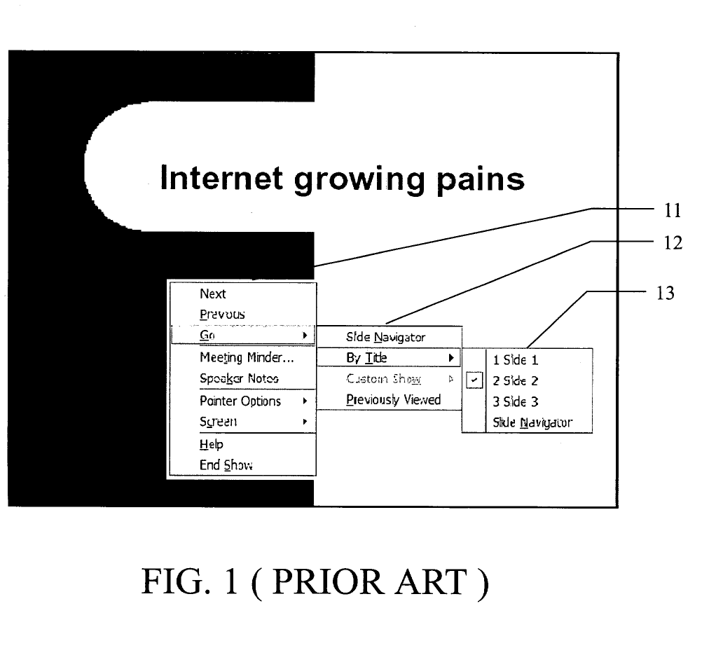

### DETAILED DESCRIPTION OF THE INVENTION

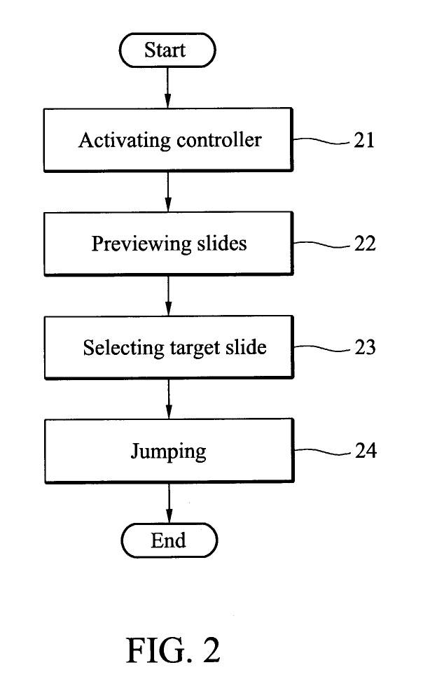

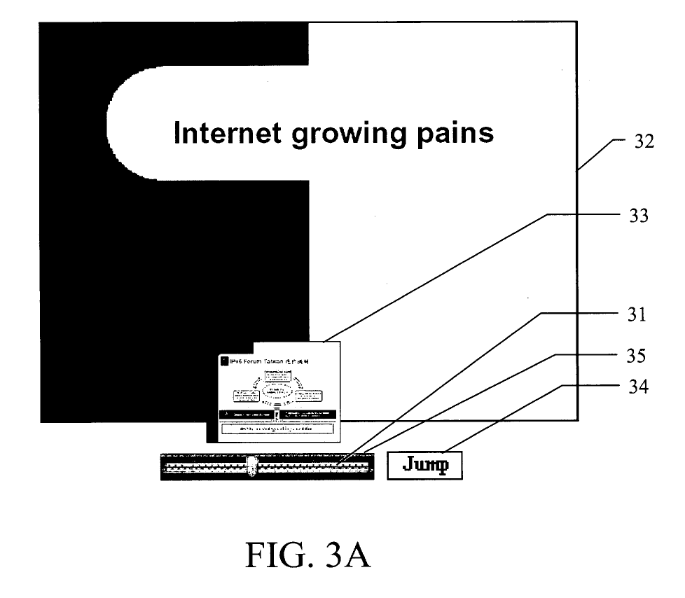

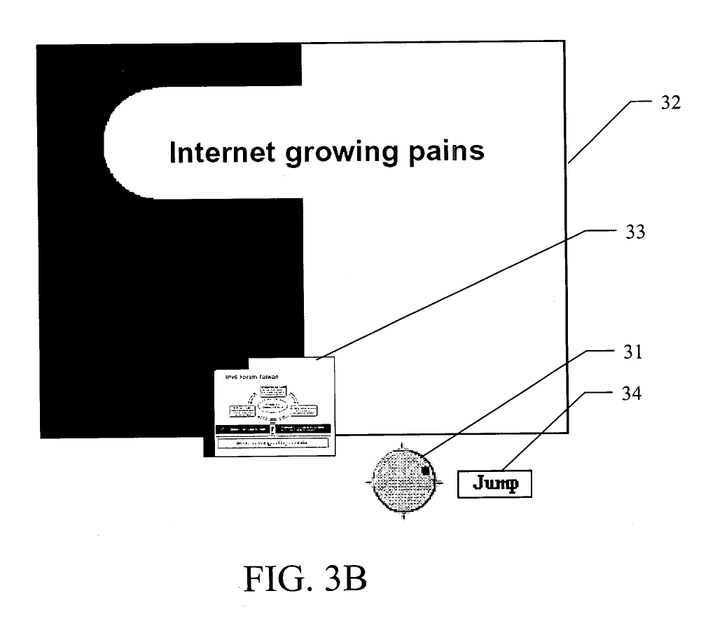

FIG. 2 is a diagram showing a method for a non-sequential slideshow presentation according to one embodiment of the invention. The method will be explained in the following using FIG. 2 accompanied with FIG. 3A showing a graphical user interface therefor.

In step 21, a selection controller 31 and jump button 34, as shown in FIG. 3A, are activated and appear below a main window 32 when the user right-clicks the slide currently displayed in the main window 32. The selection controller 31 and jump button 34 are hidden and the slides displayed in the main window 32 are switched in an order of their sequential indices by default until the user activates the selection controller 31 and jump button 34. The selection controller 31 shown in FIG. 3A is a slider.

In step 22, the slides in the slideshow are previewed in sequence when the user drags the slider 31 back and forth. In the meantime, a preview window 33 appears above the slider 31, wherein thumbnails of the previewed slides are shown. The slide shown in the main window 32 is kept unchanged and only the thumbnails shown in the preview window 33 change, corresponding to the movement of the slider 31 when dragged.

In step 23, when the user stops dragging and releases the slider 31, the currently previewed slide is selected as a target slide. The main window 32 accordingly displays the target slide.

In step 24, when the user pushes the jump button 34, the the main window 32 displays the previously displayed slide.

In the previously described embodiment, the preview window 33 greatly helps the user to identify the target slide without the need to remember its title or index. Alternatively, the slides previewed in sequence by the slider 31 may be directly shown in the main widow 32 without displaying their thumbnails in the preview window 33 when the user drags the slider 31. However, for slides requiring large data processing, the user will suffer an incomplete or delayed display of the slides when dragging the slider 31 too fast. Showing only the thumbnails of the slides in the preview window 33 eliminates this problem. Moreover, the main window 33 may switch to the currently previewed slide when the user stops moving but keeps holding the slider 31 for a period of time which is long enough for data processing of the slide.

Additionally, the bar 35 along which the slider 31 is dragged has reference points evenly distributed thereon. The reference points refer to the corresponding slides and are arranged in an order of the slide indices. The reference points are hidden in the embodiment shown in FIG. 3A. They may also be indicated by any symbol, such as dots, on the bar 35.

FIG. 3B is a diagram showing a graphical user interface in another embodiment of the invention. It is similar to that shown in FIG. 3B except that the selection controller 31 is a rotary knob rather than a slider. The user rotates the rotary knob 31 to sequentially preview the slides and the reference points are evenly distributed on the circumference of the rotary knob 31. The target slide is selected when the user stops rotating and releases the rotary knob 31.

In conclusion, the present invention provides a smart graphical user interface for a non-sequential slideshow presentation. The user can sequentially preview the content of the slides by simply dragging or rotating the selection controller, and displays a previously displayed slide by simply pushing the jump button. There is no need for troublesome menu selection as in the conventional graphical user interface.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A graphical user interface for a slideshow presentation, comprising:
a selection controller by which slides in the slideshow are previewed in sequence when a first event occurs and one of the previewed slides is selected when a second event occurs;
a preview window displaying a thumbnail for each of the slides currently previewed by the selection controller; and
a main window displaying the slide selected by the selection controller.

2. The graphical user interface as claimed in claim 1, wherein the selection controller is a slider, the first event comprising dragging the slider, and the second event comprising releasing the slider.

3. The graphical user interface as claimed in claim 1, wherein the selection controller is a rotary knob, the first event comprising rotating the rotary knob, and the second event comprising releasing the rotary knob.

4. The graphical user interface as claimed in claim 1 further comprising a jumper by which the main window displays the previously displayed slide when a third event occurs.

5. The graphical user interface as claimed in claim 4, wherein the jumper is a button and the third event comprises pushing the button.

6. The graphical user interface as claimed in claim 1, wherein the slides are sequentially indexed, the selection controller is activated only when a fourth event occurs and the main window displays the slides in an order of their indices by default.

7. The graphical user interface as claimed in claim 6, wherein the fourth event comprises right-clicking the main window.

8. A method for a slideshow presentation comprising:
previewing in sequence slides in the slide show when a first event occurs and selecting one of the previewed slides when a second event occurs;
displaying a thumbnail for each of the slides currently previewed in a preview window; and
displaying the selected slide in a main window.

9. The method as claimed in claim 8, wherein the slides are previewed using a slider, the first event comprising dragging the slider, and the second event comprising releasing the slider.

10. The method as claimed in claim 8, wherein the slides are previewed using a rotary knob, the first event comprising rotating the rotary knob, and the second event comprising releasing the rotary knob.

11. The method as claimed in claim 8 further comprising the step of switching the slide displayed from the currently selected slide to the previously displayed slide when a third event occurs.

12. The method as claimed in claim 11, wherein the slide display is changed by a button and the third event comprises pushing the button.

13. The method as claimed in claim 8, wherein the slides are sequentially indexed and are displayed in an order of their indices by default.
